(19) United States
(12) Patent Application Publication
(10) Pub. No.: US 2026/0234815 A1
(43) Pub. Date: Aug. 13, 2026

(54) POROUS WATER-SPLITTING ELECTRODE BASED ON SUPPORT COATED WITH CARBON NANONUBE ASSEMBLY, METHOD FOR MANUFACTURING SAME, AND WATER ELECTROLYSIS DEVICE INCLUDING SAME

(71) Applicant: KOREA UNIVERSITY RESEARCH AND BUSINESS FOUNDATION, Seoul (KR)

(72) Inventors: Jinhan CHO, Seoul (KR); Youhyun SON, Seoul (KR)

(73) Assignee: KOREA UNIVERSITY RESEARCH AND BUSINESS FOUNDATION, Seoul (KR)

(21) Appl. No.: 19/153,263

(22) PCT Filed: Jan. 31, 2024
(86) PCT No.: PCT/KR2024/001470

§ 371 Date: Aug. 1, 2025

(30) Foreign Application Priority Data
Feb. 2, 2023 (KR) 10-2023-0014341

(51) Int. Cl. C25B 11/069; C25B 1/04; C25B 11/031; C25B 11/052; C25B 11/075; C25B 11/091; C25D 3/12; C25D 3/56; C25D 5/14; C25D 5/54

(52) U.S. Cl. CPC C25B 11/069; C25B 11/031; C25B 11/052; C25B 11/075; C25B 11/091; C25D 3/12; C25D 3/562; C25D 5/14; C25D 5/54; C25B 1/04

(57) ABSTRACT

The present invention relates to a porous water-splitting electrode including a support coated with a carbon nanotube assembly and a catalytic active layer formed on the coated support; a method of manufacturing the same; and a water electrolysis device including the same.

### TECHNICAL FIELD

The present invention relates to a porous water-splitting electrode based on a support coated with a carbon nanotube assembly, a method of manufacturing the same, and a water electrolysis device including the same.

### BACKGROUND ART

As the use of fossil fuels such as petroleum and coal has accumulated, serious environmental problems have arisen. In response, there is a global movement to achieve carbon neutrality by reducing greenhouse gas emissions, particularly carbon dioxide. Although various renewable energy sources have been studied to replace fossil fuels, the most representative sources, wind and solar power, have encountered the issue of “output limitation” due to seasonal and hourly imbalances in power generation. Hydrogen, on the other hand, does not emit toxic gases when used as a fuel and can generate a high amount of energy relative to its weight. As a result, there is increasing discussion about using hydrogen as an energy storage medium by converting surplus electricity into hydrogen for storage. Interest in hydrogen energy and the hydrogen economy is rapidly growing, with many countries and companies announcing national hydrogen strategies and plans to promote hydrogen-related projects.

There are conventional methods for hydrogen production such as steam methane reforming and coal gasification, but these methods require high temperature and high pressure conditions and have the drawback of emitting carbon dioxide during hydrogen production. As a result, attention is being focused on environmentally friendly water electrolysis methods that utilize electrolysis.

For a water-splitting catalyst, not only high hydrogen evolution performance but also high oxygen evolution performance in the same electrolyte are required to achieve overall high water electrolysis efficiency. In addition, as water is decomposed, intermediates repeatedly are adsorbed and desorbed on/from the catalyst surface, and this process determines the activation energy of the catalyst. Therefore, in order to achieve efficient water electrolysis, it is necessary to maximize the number of active sites on the catalyst surface and facilitate rapid charge transfer.

For the commercialization of hydrogen production through water electrolysis, it is necessary for electrodes to operate at low voltages and maintain stability for a long time even under high current conditions. At high current, increased resistance may lead to a rise in temperature, and the generation of hydrogen and oxygen gases may cause gas pressure, which may result in the desorption and delamination of the electrode support and the catalyst layer. Such degradation reduces the stability of the electrode. Therefore, research is needed on electrode manufacturing methods that can provide high stability and sustain water electrolysis performance for a long time.

The most commonly used metals for conventional water-splitting catalysts are platinum (Pt) for the cathode and iridium (Ir) and ruthenium (Ru) for the anode. Due to the high cost of these precious metals, they are typically used in the form of nanoparticles or powders to maximize surface area with a limited amount. However, these forms cannot be used alone and are therefore blended with carbon black and Nafion polymer before being introduced onto a support. These precious metals are extremely expensive, and the low hygroscopicity of carbon black affects the contact area between the electrolyte and the catalytic active sites. In addition, the use of Nafion, which is an insulating material, reduces charge transfer, ultimately leading to decreased catalytic performance.

As non-precious metal catalysts for water splitting, a nickel-molybdenum (NiMo) alloy and a nickel-iron (NiFe) alloy can serve as catalysts for the hydrogen evolution reaction and the oxygen evolution reaction, respectively. The NiMo alloy can split the HO-H bond, and the dissociated intermediate Had is adsorbed with appropriate strength, making it easy to recombine into hydrogen. In the case of the NiFe alloy, it is known that Fe contributes to the formation of nickel oxyhydroxide (NiOOH), which is a key substance for oxygen evolution. These non-precious metal alloys exhibit excellent conductivity and have the advantage of being used as standalone catalyst electrodes without the need for additional binders.

Although various porous materials such as metal foam (Ni foam, Cu foam), carbon paper, and titanium paper have been used as current collectors to develop water-splitting electrodes with gas diffusion capabilities by coating them with catalysts, existing technologies have limitations in maximizing the surface area and the amount of catalyst that can be loaded. Therefore, there is a need for research on the development of water-splitting electrodes that maximize surface area by using textile materials as supports.

There are several limitations to applying previously reported technologies to the manufacture of textile-based electrodes. Therefore, it is necessary to develop electrodes that can be manufactured and controlled simply, rapidly, and efficiently. In addition, there is a need to develop water-splitting electrodes and their manufacturing methods that exhibit excellent electrical properties, catalytic performance, and outstanding stability, based on a maximized surface area.

### DISCLOSURE

### Technical Problem

The present invention aims to provide a porous water-splitting electrode with high catalytic performance and excellent stability, which includes: a support coated with a carbon nanotube assembly; and a catalytic active layer formed on the coated support.

However, the technical problems to be solved by the present invention are not limited to those described above, and other problems not mentioned can be clearly understood by those skilled in the art from the description below.

### Technical Solution

The present invention provides a porous water-splitting electrode including: a support coated with a carbon nanotube assembly; and a catalytic active layer formed on the coated support.

The support may include one or more fabrics selected from the group consisting of cotton fiber, silk fiber, cellulose, polyester, nylon, acrylic fiber, and polyacrylonitrile fiber.

The carbon nanotubes in the carbon nanotube assembly may be modified with a carboxyl group, an amine group, or a thiol group.

When the carbon nanotubes in the carbon nanotube assembly are modified with a carboxyl group, the support may be modified with a first amine group, and a hydrogen bond may be formed between the carboxyl group and the first amine group.

When the carbon nanotubes in the carbon nanotube assembly are modified with a carboxyl group, the carbon nanotube assembly may further include an organic compound containing a second amine group, and a hydrogen bond may be formed between the carboxyl group and the second amine group.

The organic compound containing the second amine group may have a weight-average molecular weight of 50 g mol⁻¹ to 500 g mol⁻¹.

The catalytic active layer may include a catalyst metal layer and any one of an alloy layer, a hydroxide layer, an oxyhydroxide layer, and a double layer of a hydroxide and an oxyhydroxide, which is formed on the catalyst metal layer.

The catalyst metal layer may include one or more metals selected from the group consisting of nickel (Ni), cobalt (Co), iron (Fe), molybdenum (Mo), copper (Cu), vanadium (V), and tungsten (W).

When the catalytic active layer includes an alloy layer or a hydroxide layer, the electrode may be a hydrogen-evolving porous water-splitting electrode, and when the catalytic active layer includes an oxyhydroxide layer or a double layer of a hydroxide and an oxyhydroxide, the electrode may be an oxygen-evolving porous water-splitting electrode.

One aspect of the present invention provides a method of manufacturing a porous water-splitting electrode, including: (a) coating a support with a carbon nanotube assembly; and (b) forming a catalytic active layer on the coated support.

Another aspect of the present invention provides a water electrolysis device including the above porous water-splitting electrode.

### Advantageous Effects

A porous water-splitting electrode according to the present invention has a porous structure based on a support coated with a carbon nanotube assembly (particularly, a dual-porous structure composed of a textile support and a carbon nanotube assembly), which enables the easy release of hydrogen or oxygen generated at the catalyst surface, has excellent charge transport capability by allowing easy penetration of the electrolyte, and exhibits high water-splitting performance. In addition, the porous water-splitting electrode of the present invention can exhibit high operational stability, which can maintain a low voltage for a long time even under high current conditions, due to the strong adhesion between the carbon nanotube assembly and the catalyst metal layer, and can be manufactured without restrictions on size or shape, making it highly useful for manufacturing water electrolysis devices and related applications.

### DESCRIPTION OF DRAWINGS

FIG. 1 is a schematic diagram illustrating the process of manufacturing a porous water-splitting electrode based on a textile support coated with a carbon nanotube assembly according to the present invention.

FIG. 2 shows (a) a (preliminary) sheet resistance graph according to the type of organic compound containing a second amine group (TREN, PEI, NH₂-MWCNT) and the number of carbon nanotube layers (n≤20) on a Si wafer support coated with a carbon nanotube assembly, and (b) a sheet resistance graph according to the number of carbon nanotube layers (n≤20) on a textile support coated with a carbon nanotube assembly ((COOH-MWCNT/TREN)ₙ-textile) according to the present invention.

FIG. 3 shows (a) a scanning electron microscope (SEM) image and (b) a Brunauer-Emmett-Teller (BET) specific surface area analysis graph of a porous water-splitting electrode (Ni-ED CTT) based on a textile support coated with a carbon nanotube assembly according to the present invention.

FIG. 4 shows cross-sectional SEM images and energy-dispersive X-ray spectroscopy (EDX) elemental mapping images of a porous water-splitting electrode based on a textile support coated with a carbon nanotube assembly according to the present invention, after additional electroplating of (a) NiMo and (b) NiFe.

FIG. 5 shows the electrochemical properties of (a) a hydrogen-evolving porous water-splitting electrode (NiMo-ED CTT) based on a textile support coated with a carbon nanotube assembly according to the present invention, and (b) an oxygen-evolving porous water-splitting electrode (NiFe-ED CTT) based on a textile support coated with a carbon nanotube assembly according to the present invention, in a 1 M KOH electrolyte.

FIG. 6 shows the stability analysis results of (a) a hydrogen-evolving porous water-splitting electrode (NiMo-ED CTT) based on a textile support coated with a carbon nanotube assembly according to the present invention, and (b) an oxygen-evolving porous water-splitting electrode (NiFe-ED CTT) based on a textile support coated with a carbon nanotube assembly according to the present invention, in a 1 M KOH electrolyte.

### BEST MODE

Accordingly, as a result of extensive efforts to solve the problems of conventional water-splitting catalysts and electrodes, the present invention was completed by coating a support with a carbon nanotube assembly through design of an interface based on hydrogen bonding, and then forming a catalytic active layer, thereby manufacturing a porous water-splitting electrode with high catalytic performance and excellent stability.

Hereinafter, the present invention will be described in detail.

The present invention provides a (integrated type) porous water-splitting electrode including a support coated with a carbon nanotube assembly; and a catalytic active layer formed on the coated support.

First, the porous water-splitting electrode according to the present invention includes a surface-treated support (current collector) that is coated with a carbon nanotube assembly and exhibits both conductivity and hydrophilicity.

The support (prior to surface treatment) may have a porous structure and may be an insulating textile support in which multiple fibers are interwoven, with numerous pores formed at the intersections of the fibers. These fibers are long, thin, and flexible filamentous materials, and may include natural and synthetic fibers. Accordingly, the textile support may have flexibility by being woven from natural fibers alone, synthetic fibers alone, or a blend of these fibers. Specifically, the textile support may include one or more selected from the group consisting of cotton fiber, silk fiber, cellulose, polyester, nylon, acrylic fiber, and polyacrylonitrile fiber.

The support that has been surface-treated in this way is coated with a carbon nanotube assembly through an interfacial design based on hydrogen bonding. The carbon nanotube assembly forms an additional porous structure, thereby further increasing the surface area.

In particular, the carbon nanotube assembly may be a multilayer structure in which carbon nanotubes are stacked by layer-by-layer (LbL) assembly or deposition, which may enhance the surface area. The number of carbon nanotube layers may be about 5 to about 50, and as the number of carbon nanotube layers increases, sheet resistance decreases while electrical conductivity increases.

The carbon nanotubes in the carbon nanotube assembly may be modified with a carboxyl group (—COOH), an amine group (—NH₂), or a thiol group (—SH). In this way, various functional groups form chemical bonds with the catalyst metal layer described below, thereby making it possible to manufacture a water-splitting catalyst with excellent stability.

When the carbon nanotubes in the carbon nanotube assembly are modified with a carboxyl group, the support may be modified with a first amine group, and a hydrogen bond may be formed between the carboxyl group and the first amine group. At this time, the first amine group is introduced into the support, and the support may be finally modified with the first amine group by first modifying the support with a hydroxyl group and then immersing it in a poly(ethyleneimine) (PEI) solution. Meanwhile, the carboxyl group may be present at the interface between the support and the carbon nanotube assembly in order to form a hydrogen bond with the first amine group.

When the carbon nanotubes in the carbon nanotube assembly are modified with a carboxyl group, the carbon nanotube assembly may further include an organic compound containing a second amine group, and a hydrogen bond may be formed between the carboxyl group and the second amine group. Meanwhile, the carboxyl group may be present within the carbon nanotube assembly in order to form a hydrogen bond with the second amine group. In addition, the organic compound containing the second amine group may have a weight average molecular weight of 50 g mol⁻¹ to 500 g mol⁻¹. Specifically, it may be a small-molecule/monomeric linker such as tris(2-aminoethyl)amine (TREN) or diethylenetriamine (DETA), with TREN being preferred, but is not limited thereto. This significantly reduces the contact resistance between adjacent carboxyl-modified carbon nanotubes and may further decrease the volume of the carbon nanotube assembly.

Next, the porous water-splitting electrode according to the present invention includes a catalytic active layer formed on the coated support.

The catalytic active layer may include a catalyst metal layer and any one of an alloy layer, a hydroxide layer, an oxyhydroxide layer and a double layer of a hydroxide and an oxyhydroxide, which is formed on the catalyst metal layer.

The catalyst metal layer may include one or more metals (preferably, two or more metals) selected from the group consisting of nickel (Ni), cobalt (Co), iron (Fe), molybdenum (Mo), copper (Cu), vanadium (V), and tungsten (W). The catalyst metal layer may include Ni and, to further enhance performance, may additionally include Li and Mo or two or more metals selected from the group consisting of Ni, Co, and Fe.

When the catalytic active layer includes an alloy layer or a hydroxide layer, it may serve as a hydrogen-evolving porous water-splitting electrode. In this case, the catalyst metal layer may include Ni, and additional porous structures may be formed through Ni electroplating, thereby further increasing the surface area. To further enhance performance, Ni and Mo may be additionally included. For the porous water-splitting electrode according to one embodiment of the present invention, after Ni electroplating, additional electroplating of Ni and Mo was performed to use the porous water-splitting electrode as a reduction electrode for the hydrogen evolution reaction (HER). At this time, the formation of alloys such as NiMo or hydroxides such as Ni(OH)₂ (particularly, an alloy form such as NiMo) may improve hydrogen evolution performance.

Meanwhile, when the catalytic active layer includes an oxyhydroxide layer or a double layer of hydroxide and oxyhydroxide, it may serve as an oxygen-evolving porous water-splitting electrode. In this case, the catalyst metal layer may include Ni, and additional porous structures may be formed through Ni electroplating, thereby further increasing the surface area. To enhance performance, two or more metals selected from the group consisting of Ni, Co, and Fe may be additionally included. For the porous water-splitting electrode according to one embodiment of the present invention, after Ni electroplating, additional electroplating of Ni and Fe was performed to use the porous water-splitting electrode as an oxidation electrode for the oxygen evolution reaction (OER). In this case, the formation of oxyhydroxides such as NiOOH and FeOOH or a double layer of hydroxide and oxyhydroxide such as Ni(OH)₂ and NiOOH, FeOOH may improve oxygen evolution performance.

Additionally, the present invention provides a method of manufacturing a (integrated type) porous water-splitting electrode, including: (a) coating a support with a carbon nanotube assembly; and (b) forming a catalytic active layer on the coated support.

In the method of manufacturing the porous water-splitting electrode according to the present invention, the “support,” “carbon nanotube assembly,” and “catalytic active layer” have been described above, so redundant descriptions thereof will be omitted.

In the method of manufacturing the porous water-splitting electrode according to the present invention, step (a) includes coating the carbon nanotube assembly via multilayer stacking through layer-by-layer (LbL) assembly or deposition of carbon nanotubes and/or an organic compound containing a second amine group, thereby increasing the surface area and providing pathways for the electrolyte solution as a reactant and hydrogen and oxygen gases as products to permeate.

In step (b), the catalytic active layer may be formed by electroplating of catalyst metals, specifically by nickel (Ni) electroplating, additional electroplating of nickel (Ni) and molybdenum (Mo), and/or additional electroplating of two or more metals selected from the group consisting of nickel (Ni), cobalt (Co), and iron (Fe). This process enables uniform coating, and since it is accomplished simply and quickly, it may shorten the time for manufacturing the porous water-splitting electrode, reduce production costs, and enable efficient control.

Specifically, the Ni electroplating, the additional electroplating of Ni and Mo, and/or the additional electroplating of two or more metals selected from the group consisting of Ni, Co, and Fe may be performed using electroplating solutions containing the corresponding catalyst metal-based oxides/hydroxides. These processes may be carried out at a current density of about 10 mA cm⁻² to about 500 mA cm⁻² for about 1 minute to about 60 minutes. More specifically, the Ni electroplating may be performed at a current density of about 300 mA cm⁻² to about 400 mA cm⁻² for about 1 minute to about 20 minutes. The additional electroplating of Ni and Mo may be performed at a current density of about 100 mA cm⁻² to about 200 mA cm⁻² for about 1 minute to about 20 minutes. The additional electroplating of two or more metals selected from the group consisting of Ni, Co, and Fe may be performed at a current density of about 10 mA cm⁻² to about 100 mA cm⁻² for about 10 minutes to about 30 minutes. Through these processes, an alloy layer, a hydroxide layer, an oxyhydroxide layer, or a double layer of hydroxide and oxyhydroxide may be formed on the catalyst metal layer, thereby manufacturing the catalytic active layer, and as a result, the porous water-splitting electrode may be finally manufactured.

In addition, the present invention provides a water electrolysis device including the above porous water-splitting electrode.

The water electrolysis device according to the present invention is a device that produces hydrogen and oxygen by utilizing electrons generated during the redox reaction of water, and may be, for example, a membrane electrode assembly in which an anode and a cathode are coated on both sides of an electrolyte membrane. In addition, the water electrolysis device of the present invention may be utilized as a water electrolysis system. Since the “porous water-splitting electrode” has been described above, a redundant description thereof will be omitted.

Accordingly, the porous water-splitting electrode according to the present invention has a porous structure based on a support coated with a carbon nanotube assembly (particularly, a dual-porous structure composed of a textile support and a carbon nanotube assembly), which allows hydrogen or oxygen generated at the catalyst surface to be easily released, has excellent charge transport capability by allowing easy penetration of the electrolyte, and exhibits high water-splitting performance. In addition, the porous water-splitting electrode of the present invention may exhibit high operational stability, which is capable of maintaining a low voltage for a long time even under high current conditions, due to the strong adhesion between the carbon nanotube assembly and the catalyst metal layer, and may be manufactured without restrictions on size or shape, making it highly useful for manufacturing water electrolysis devices and related applications.

Hereinafter, the present invention will be described in detail based on preferred examples of the present invention. However, the technical idea of the present invention is not limited or restricted thereto and may be modified and implemented in various ways by those skilled in the art.

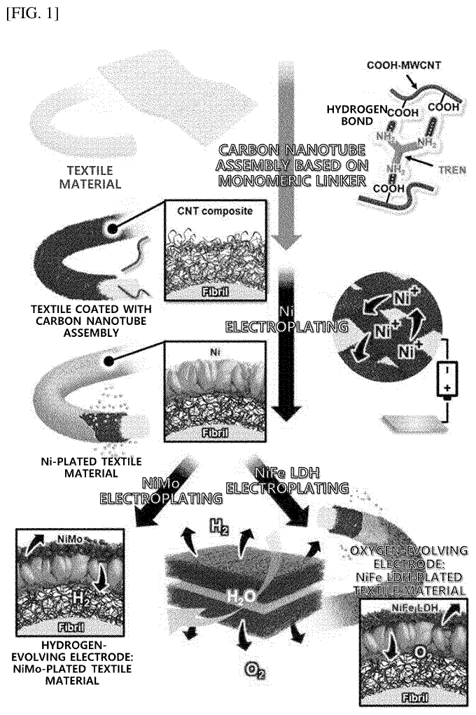

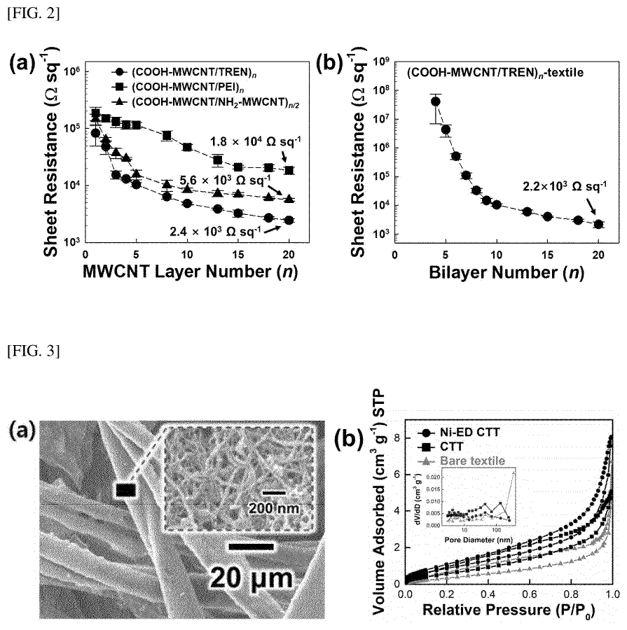

### Example 1: Manufacture of Hydrogen/Oxygen-Evolving Porous Water-Splitting Electrode According to the Present Invention (FIG. 1)

### 1-1: Surface Modification of Textile Support

A cotton fabric with a width of about 14.6 μm and a thickness of about 790 μm was purchased from Cotton Day (Korea). The cotton fabric was composed of cellulose fibrils modified with hydroxyl groups (OH), and was immersed in a poly(ethyleneimine) (PEI) solution overnight to prepare a cotton fabric surface-modified with amine groups.

### 1-2: Surface Modification of Carbon Nanotubes

Pristine multi-walled carbon nanotubes (MWCNTs) with a diameter of 7-9 nm, a length of 10-50 μm, and a purity greater than 80% (Nanosolution Co. Ltd.) were treated with a strongly acidic mixture of H₂SO₄/HNO₃ at 80° C. for 2.5 hours. After the reaction, the MWCNTs surface-modified with carboxyl groups (COOH-MWCNTs) were washed several times by centrifugation and vacuum filtration to remove by-products and/or acidic residues. Subsequently, the COOH-MWCNTs were redispersed in ethanol.

### 1-3: Coating of Carbon Nanotube Assembly on Textile Support

For the layer-by-layer (LbL) assembly coating of carbon nanotubes on the surface-modified cotton fabric, a mixed solution was first prepared by combining the ethanol dispersion (2 mg mL⁻¹) of COOH-MWCNTs prepared in Example 1-2 with an ethanol dispersion (2 mg mL⁻¹) of tris(2-aminoethyl)amine (TREN, M_{w}~146 g mol⁻¹). Afterward, the surface-modified cotton fabric prepared in Example 1-1 was immersed in the mixed solution for 10 minutes. This process was repeated to obtain a (MWCNT/TREN)ₙ-coated cotton fabric with the desired number of layers (n).

### 1-4: Manufacture of Porous Water-Splitting Electrode

A porous water-splitting electrode was manufactured by performing Ni electroplating on the (MWCNT)ₙ-coated cotton fabric manufactured in Example 1-3.

Specifically, Ni electroplating was performed at a current density of 360 mA/cm² for 5 minutes in a Watt bath nickel plating solution (240 g/L NiSO₄, 45 g/L NiCl₂, 30 g/L H₃BO₃), using the (MWCNT)ₙ-coated cotton fabric as the cathode and a nickel plate as the anode (Ni loading: 40.6 mg/cm²). Subsequently, the plated electrode was washed three times with deionized water and dried at room temperature to obtain a Ni-ED (MWCNT/TREN)ₙ-coated cotton fabric.

### 1-5: Manufacture of Hydrogen-Evolving Porous Water-Splitting Electrode

To enhance the hydrogen evolution performance of the Ni-ED (MWCNT/TREN)ₙ-coated cotton fabric manufactured in Example 1-4, additional electroplating of Ni and Mo was performed to manufacture a hydrogen-evolving porous water-splitting electrode.

Specifically, the additional NiMo electroplating was performed at a current density of 150 mA/cm² for 10 minutes in an aqueous electrolyte bath containing 80 g/L NiSO₄, 50 g/L Na₂MoO₄, 90 g/L Na₃C₆H₅O₇, and an excess of NH₄OH, using the Ni-ED (MWCNT/TREN)ₙ-coated cotton fabric as the cathode and a nickel plate as the anode (NiMo loading: 4.5mg/cm²). After electrodeposition, the coated electrode was washed three times with deionized water and dried at room temperature to obtain an NiMo-ED (MWCNT/TREN)ₙ-coated cotton fabric with additional NiMo electroplating.

### 1-6: Manufacture of Oxygen-Evolving Porous Water-Splitting Electrode

To enhance the oxygen evolution performance of the Ni-ED(MWCNT/TREN)ₙ-coated cotton fabric manufactured in Example 1-4, additional electroplating of Ni and Fe was performed to manufacture an oxygen-evolving porous water-splitting electrode.

Specifically, the additional NiFe electroplating was performed at a current density of 10 mA/cm² for 10 minutes in an aqueous electrolyte bath containing 3 mM Ni(NO₃)₂·6H₂O and 3 mM Fe(NO₃)₃·9H₂O, using the Ni-ED (MWCNT/TREN)ₙ-coated cotton fabric as the cathode and a nickel plate as the anode (NiFe loading: 4.3 mg/cm²). After electrodeposition, the coated electrode was washed three times with deionized water and dried at room temperature to obtain an NiFe-ED (MWCNT/TREN)ₙ-coated cotton fabric with additional NiFe electroplating. At this time, even without a post-treatment process, a double layer of hydroxide and oxyhydroxide, including hydroxides such as Ni(OH)₂ and oxyhydroxides such as NiOOH and FeOOH, was formed.

### Example 2: Sheet Resistance of Textile Support Coated With Carbon Nanotube Assembly According to the Present Invention

As a preliminary experiment, the sheet resistance of a Si wafer support coated with a carbon nanotube assembly was analyzed (FIG. 3A).

As shown in FIG. 3A, the (MWCNT/TREN)ₙ-coated Si wafer exhibited a decrease in sheet resistance and an increase in electrical conductivity as the number of carbon nanotube layers increased. In particular, for the textile support coated with a carbon nanotube assembly according to the present invention, when the organic compound containing the second amine group was a small-molecule/monomeric linker (TREN) with a low molecular weight, the sheet resistance was further reduced compared to when PEI or NH₂-MWCNT was used.

Subsequently, the sheet resistance of the textile support coated with a carbon nanotube assembly ((MWCNT/TREN)ₙ₋coated cotton fabric or (COOH-MWCNT/TREN)ₙ-textile) manufactured in Example 1-3 was analyzed (FIG. 3B).

As shown in FIG. 3B, the (MWCNT/TREN)ₙ-coated cotton fabric also exhibited a decrease in sheet resistance and an increase in electrical conductivity as the number of carbon nanotube layers increased.

### Example 3: Characteristics of Porous Water-Splitting Electrode According to the Present Invention

The porous water-splitting electrode (Ni-ED (MWCNT/TREN)ₙ-coated cotton fabric or Ni-ED CTT) manufactured in Example 1-4 was analyzed through scanning electron microscopy (SEM) and Brunauer-Emmett-Teller (BET) specific surface area analysis (FIG. 3).

As shown in FIG. 3, the Ni-ED (MWCNT/TREN)ₙ-coated cotton fabric maintained a porous structure with a high surface area, demonstrating an improvement compared to both (MWCNT/TREN)ₙ-coated cotton fabric and bare textile. This is because, in addition to the porous structure of the cotton fabric, the carbon nanotube assembly and/or the Ni electroplating form additional porous structures, thereby further increasing the surface area.

### Example 4: Characteristics, Performance, and Stability of Hydrogen/Oxygen-Evolving Porous Water-Splitting Electrodes According to the Present Invention

### 4-1: Characteristics of Hydrogen/Oxygen-Evolving Porous Water-Splitting Electrodes

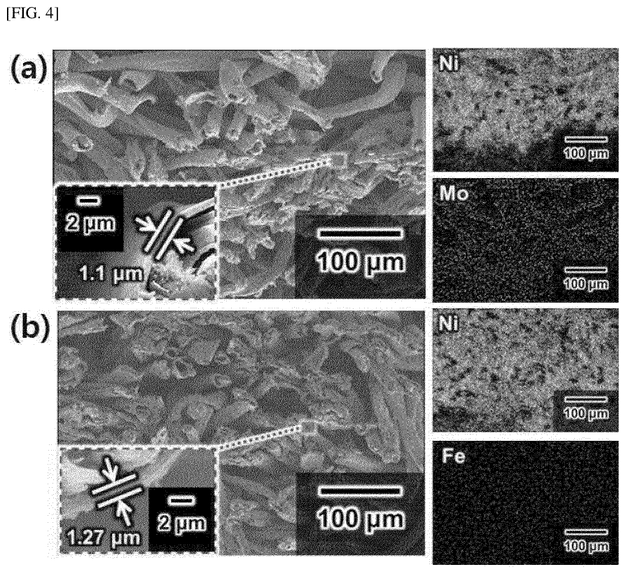

The hydrogen-evolving porous water-splitting electrode (NiMo-ED (MWCNT/TREN)ₙ-coated cotton fabric) manufactured in Example 1-5 and the oxygen-evolving porous water-splitting electrode (NiFe-ED (MWCNT/TREN)ₙ-coated cotton fabric) manufactured in Example 1-6 were analyzed by scanning electron microscopy (SEM) and energy-dispersive X-ray spectroscopy (EDX) (FIG. 4).

As shown in FIG. 4, it can be seen that the NiMo-ED (MWCNT/TREN)ₙ-coated cotton fabric maintained a porous structure while Ni and Mo were uniformly electroplated. Similarly, NiFe-ED (MWCNT/TREN)ₙ-coated cotton fabric maintained a porous structure while Ni and Fe were uniformly electroplated.

### 4-2: Hydrogen Evolution Performance and Stability

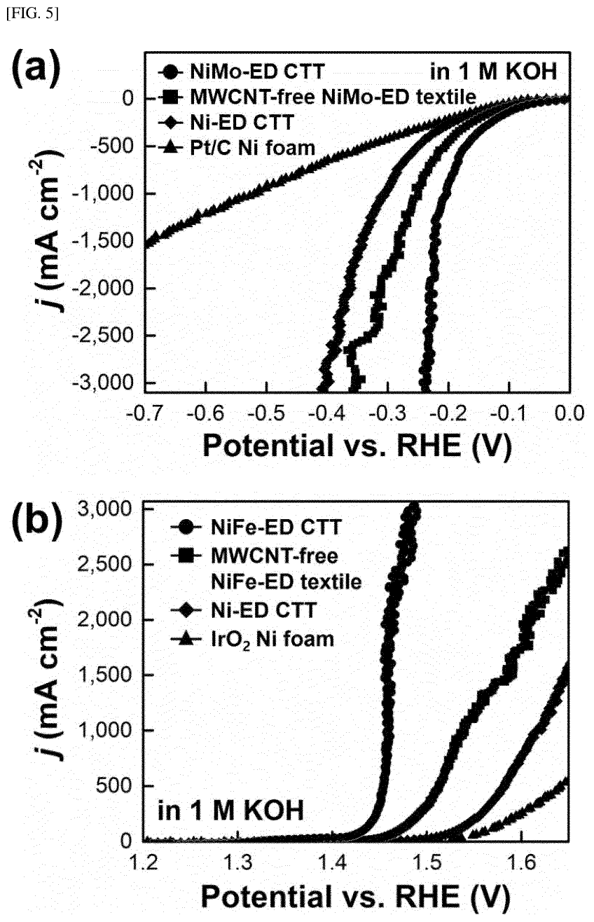

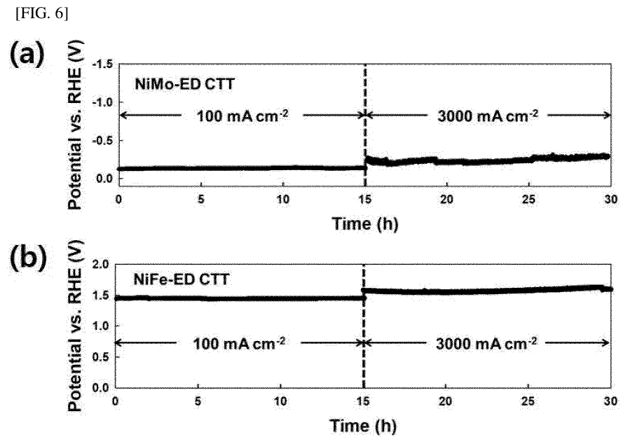

The hydrogen-evolving porous water-splitting electrode (NiMo-ED (MWCNT/TREN)ₙ-coated cotton fabric or NiMo-ED CTT) manufactured in Example 1-5 was analyzed through linear sweep voltammetry (LSV) in a 1 M KOH electrolyte to evaluate its hydrogen evolution performance and overpotential (FIGS. 5A and 6A). All reported current densities are based on the geometric surface area of the electrode.

As shown in FIG. 5A, the NiMo-ED (MWCNT/TREN)ₙ-coated cotton fabric exhibited excellent hydrogen evolution performance, which was improved compared to the Ni-ED (MWCNT/TREN)ₙ-coated cotton fabric and Pt/C Ni foam. Furthermore, as shown in FIG. 6A, the NiMo-ED (MWCNT/TREN)ₙ-coated cotton fabric maintained a constant voltage for 30 hours or more when operated for a long time at various current densities (100 mA cm⁻² and 3,000 mA cm⁻²), indicating high stability.

### 4-3: Oxygen Evolution Performance and Stability

The oxygen-evolving porous water-splitting electrode (NiFe-ED (MWCNT/TREN)ₙ-coated cotton fabric or NiFe-ED CTT) manufactured in Example 1-6 was analyzed through linear sweep voltammetry (LSV) in a 1 M KOH electrolyte to evaluate its oxygen evolution performance and overpotential (FIGS. 5B and 6B). All reported current densities are based on the geometric surface area of the electrode.

As shown in FIG. 5B, the NiFe-ED (MWCNT/TREN)ₙ-coated cotton fabric exhibited excellent oxygen evolution performance, which was improved compared to the Ni-ED (MWCNT/TREN)ₙ-coated cotton fabric and IrO₂ Ni foam. Furthermore, as shown in FIG. 6B, the NiFe-ED (MWCNT/TREN)ₙ-coated cotton fabric maintained a constant voltage for 30 hours or more when operated for a long time at various current densities (100 mA cm⁻² and 3,000 mA cm⁻²), indicating high stability.

The description of the present invention described above is for illustrative purposes, and those skilled in the art will understand that the present invention can be easily modified into other specific forms without changing the technical idea or essential features of the present invention. Therefore, the examples described above should be understood in all respects as illustrative and not restrictive.

1. A porous water-splitting electrode comprising:
a support coated with a carbon nanotube assembly; and
a catalytic active layer formed on the coated support.

2. The porous water-splitting electrode of claim 1, wherein the support includes one or more fabrics selected from the group consisting of cotton fiber, silk fiber, cellulose, polyester, nylon, acrylic fiber, and polyacrylonitrile fiber.

3. The porous water-splitting electrode of claim 1, wherein the carbon nanotubes in the carbon nanotube assembly are modified with a carboxyl group, an amine group, or a thiol group.

4. The porous water-splitting electrode of claim 1, wherein, when the carbon nanotubes in the carbon nanotube assembly are modified with a carboxyl group, the support is modified with a first amine group, and a hydrogen bond is formed between the carboxyl group and the first amine group.

5. The porous water-splitting electrode of claim 1, wherein, when the carbon nanotubes in the carbon nanotube assembly are modified with a carboxyl group, the carbon nanotube assembly further includes an organic compound containing a second amine group, and a hydrogen bond is formed between the carboxyl group and the second amine group.

6. The porous water-splitting electrode of claim 5, wherein the organic compound containing the second amine group has a weight average molecular weight of 50 g mol⁻¹ to 500 g mol⁻¹.

7. The porous water-splitting electrode of claim 1, wherein the catalytic active layer includes a catalyst metal layer and any one of an alloy layer, a hydroxide layer, an oxyhydroxide layer and a double layer of a hydroxide and an oxyhydroxide, which is formed on the catalyst metal layer.

8. The porous water-splitting electrode of claim 7, wherein the catalyst metal layer includes one or more metals selected from the group consisting of nickel (Ni), cobalt (Co), iron (Fe), molybdenum (Mo), copper (Cu), vanadium (V), and tungsten (W).

9. The porous water-splitting electrode of claim 1, wherein, when the catalytic active layer includes an alloy layer or a hydroxide layer, the electrode is a hydrogen-evolving porous water-splitting electrode, and when the catalytic active layer includes an oxyhydroxide layer or a double layer of a hydroxide and an oxyhydroxide, the electrode is an oxygen-evolving porous water-splitting electrode.

10. A method of manufacturing a porous water-splitting electrode, comprising:
(a) coating a support with a carbon nanotube assembly; and
(b) forming a catalytic active layer on the coated support.

11. A water electrolysis device comprising the porous water-splitting electrode according to claim 1.
